(19) United States
(12) Patent Application Publication
(10) Pub. No.: US 2008/0169026 A1
(43) Pub. Date: Jul. 17, 2008

(54) Fluid diverter and method

(76) Inventor: Terry J. Sanchez, Vacaville, CA (US)

Correspondence Address: Law Offices of John W. Carpenter, 405 Davis Court, Suite 707, San Francisco, CA, 04111, US

(21) Appl. No.: 11/652,870

(22) Filed: Jan. 11, 2007

(51) Int. Cl. F16K 11/02; F17D 3/00

(52) U.S. Cl. 137/1; 137/875

(57) ABSTRACT

An assembly for intermittently flowing a liquid having a non-electrical diverter assembly for receiving and alternately distributed a liquid. A dispensing assembly receives a distribution of liquid from a part of the non-electrical diverter assembly for intermittently dispersing the distributed liquid. Another dispensing assembly receives a distribution of liquid from another part of the non-electrical diverter assembly for intermittently dispersing the distributed liquid. A method for alternately distributing a liquid. The method includes flowing a liquid into a housing, diverting the liquid within the housing, contacting an impeller member with the diverted liquid for operating a cam assembly, and alternately distributing the liquid from the housing by operation of the cam assembly. A non-electrical diverter assembly for receiving and alternately distributing a liquid. The diverter assembly has a housing, a diverter device, a transmission assembly, a drive assembly, and a cam assembly.

### FIELD OF THE INVENTION

Embodiments of the present invention relate to an assembly for transmitting a liquid. More specifically, embodiments of the present invention provide an assembly for diverting and intermittently flowing a liquid, and a method for intermittently flowing a liquid, such as an aqueous based fluid.

### BACKGROUND OF THE INVENTION

Many conventional watering devices typically connect to a water source, such as a garden hose, in order to receive and disperse water for a multitude of reasons, e.g., watering grass or plants, or water toys where children enjoy getting sprayed by dispersed water, etc. These watering devices use water pressure to drive a gear train, which in turn creates movement of the device, or movement of a spray arm attached to the device.

Some conventional watering devices (e.g., an automatic sprinkler systems) use electronic switching solenoids to open and close valves that redirect water through piping systems to different areas in proximity to the watering devices. These conventional watering devices use an electromechanical device to turn on and off solenoid valves that redirect water flow.

Other conventional watering devices employ split the flow of water in more than one direction in order to operate separate water dispersing devices. Water is typically split by means of a tee or “Y” coupling, which reduces the initial water pressure and/or water flow rate output for each branching line relative to the input water pressure and/or water flow rate. Many water output devices require a minimum amount of water pressure and/or flow rate to operate.

In order re-direct the water flow to different end-dispersing devices while minimizing pressure and/or flow rate losses, an assembly is needed that will internally divert water after receiving water, and then alternatively send the diverted water to an exit port “A” and an exit port “B.” As water passes through exit port “A,” exit port “B” remains closed, and vice versa. The diverting cycle of alternately passing water through exit port “A” and exit port “B” is continuously repeated for a desired time. If the foregoing procedure is accomplished through the use of electronics and electromechanical solenoids, an electric power source is required. The electric power source may be either direct current from batteries or AC current from a power outlet.

Therefore, what is needed and what has been invented is a cost-effective procedure to alternately flow and intermittently disperse a liquid without employing electronics (i.e., a non-electrical procedure). What is further needed and what has been invented is an efficient, cost-effective, improved procedure and apparatus, which do not use any electronics or electromechanical solenoids (i.e., a non-electrical procedure and apparatus) for alternately flowing and intermittently dispersing a liquid, such as an aqueous base liquid (e.g., water).

### SUMMARY OF EMBODIMENTS OF THE INVENTION

Embodiments of the present invention provide an assembly for intermittently dispersing a liquid. The assembly includes a non-electrical diverter assembly for receiving and alternately distributing a liquid, and a pair dispersing assemblies that alternately receives the liquid from the non-electrical diverter assembly for subsequently intermittently dispersing the liquid.

Embodiments of the present invention also provide a method for alternately distributing a liquid. The method comprises flowing a liquid into a housing, and diverting the liquid within the housing. The method further comprises contacting an impeller member with the diverted liquid for operating a cam assembly, and alternately distributing a liquid from the housing by operation of the cam assembly.

Embodiments of the present invention further provide a non-electrical diverter assembly for receiving and alternately distributing a liquid. The diverter assembly includes a housing having a diverter device disposed therein for altering the direction of flow of a liquid. The diverter assembly also includes a fluid transmission assembly disposed in the housing for passing the liquid, and a drive assembly disposed in the housing and rotatably supported by the fluid transmission assembly. The drive assembly operates from the flow of liquid diverted by the diverter device. A cam assembly is disposed in the housing and is coupled to the drive assembly for alternately distributing the liquid from the housing.

Embodiments of the present invention also further provide an assembly for intermittently dispersing a liquid. The assembly comprises a diverter means for receiving and alternately distributing a liquid; a first means, communicating with the diverter means, for intermittently dispersing liquid received from the diverter means; and a second means, communicating with the diverter means, for intermittently dispersing liquid received from the diverter means.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a partial perspective cutaway view of the diverter assembly.

FIG. 2 is a partial perspective segmented view of the diverter assembly.

FIG. 3A is partial perspective segmented view of the diverter assembly illustrated in FIG. 2.

FIG. 3B is a partial vertical sectional view of a perforated member having openings slidably receiving and/or engaging stanchions attached to the diverter support member.

FIG. 4A is a partial perspective segmented view of parts of the diverter assembly.

FIG. 4B is a vertical sectional view taken in direction of the arrows and along the plane of line 4B-4B in FIG. 4A.

FIG. 4C is a vertical sectional view taken in direction of the arrows and along the plane of line 4C-4C in FIG. 4A.

FIG. 4D is a vertical sectional view taken in direction of the arrows and along the plane of line 4D-4D in FIG. 7.

FIG. 4E is a horizontal sectional view taken in direction of the arrows and along the plane of line 4E-4E in FIG. 7.

FIG. 5 is a partial perspective segmented view of parts of the diverter assembly illustrated in FIG. 4A.

FIG. 6 is a partial perspective segmented view of parts of the diverter assembly illustrated in FIG. 5.

FIG. 7 is another partial perspective segmented view of parts of the diverter assembly illustrated in FIG. 5.

FIG. 8 is a partial perspective and partial segmented view of the gear assembly.

FIG. 9 is a top plan view of the gear assembly of FIG. 8.

FIG. 10 is a bottom plan view of the gear assembly of FIG. 8.

FIG. 11 is a perspective view of parts of the diverter assembly including various parts coupled together.

FIG. 12 is a top plan view of the diverter assembly in FIG. 11.

FIG. 13 is a cut-away top plan view of the diverter assembly.

FIG. 14 is a partial cut-away top plan view of the diverter assembly.

FIG. 15 is a segmented perspective view of the diverter assembly with dashed-line arrows showing the direction for the flow of liquid.

FIG. 16 is a schematic view of the diverter assembly coupled to a fluid source with conduits extending to the slide for liquid to be dispersed thereon and extending to the jaw that moves up and down relative to the slide.

FIG. 17 is a perspective view of the slide and jaw which coupled to conduits extending from the diverter assembly.

FIG. 18 is a partial view of a pin member bound to rocker arms of the rocker member with the bound pin member rotatably passing through a bore in a shaft connected to the inside of an end of the housing, so that the rocker member may rock back and forth as tapering walls of the cam member assembly engage and disengage rocker structures supporting fluid-flow stopper members.

FIG. 19 is a vertical sectional view taken in direction of the arrows and along the plane of line 19-19 in FIG. 18.

FIG. 20 is a perspective view of another embodiment of the diverter assembly.

FIG. 21 is a segmented perspective view of the embodiment of the diverter assembly illustrated in FIG. 20.

FIG. 22 is another segmented perspective view of the embodiment of the diverter assembly illustrated in FIG. 20.

FIG. 23 is yet another segmented perspective view of the embodiment of the diverter assembly illustrated in FIG. 20.

FIG. 24 is a perspective view of the diverter assembly of FIG. 20 with arrows showing the flow of liquid.

FIG. 25 is another perspective view of the diverter assembly of FIG. 20 with arrows showing the flow of liquid.

FIG. 26 is a perspective view of the disbursement of the liquid from the liquid-emitting devices in accordance with the direction of the arrows.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Referring in detail now to the drawings wherein similar parts of various embodiments of the invention are represented by like reference numbers, there is seen for various embodiments a diverter assembly, generally illustrated as 10. The diverter assembly 10 includes a housing 12 having an inlet assembly 14 and pair of exit conduits 15 and 17. The housing 12 contains a diverter assembly 18, a liquid-passage assembly 22 coupled to the diverter assembly 18, a drive assembly 24 rotatably supported by the liquid-passage assembly 22, and a cam assembly 28 coupled to the drive assembly 24 for alternately opening and closing the exit conduits 15 and 17 to cause a liquid to alternately and/or intermittently flow through the exit conduits 15 and 17 of the housing 12.

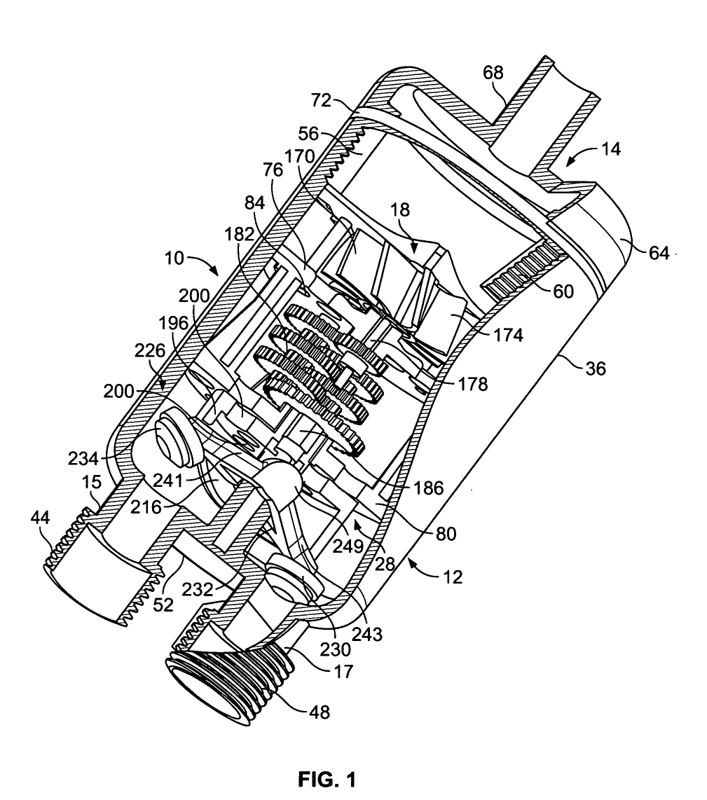

The housing 12 comprises a cylindrical shaped member 36 having internal threads 40. Exit conduits 15 and 17 are formed with external threads 44 and 48, respectively, and are integrally bound to an end 52 of the housing 12. The inlet assembly 14 includes a cylindrical member 56 with external threads 60 and has a cap 64 integrally bound thereto. The inlet assembly 14 also includes an inlet conduit 68 communicating with the insides of the inlet assembly 14. The housing 12 couples to the inlet assembly 14 by threadably engaging internal threads 40 of the cylindrical shaped member 36 with the external threads 60 of the cylindrical member 56, as best shown in FIG. 1. A gasket 72 is disposed between the cap 64 of the inlet assembly 14 and a circumferential end of the housing 12 in proximity to the internal threads 40, as best shown in FIG. 1.

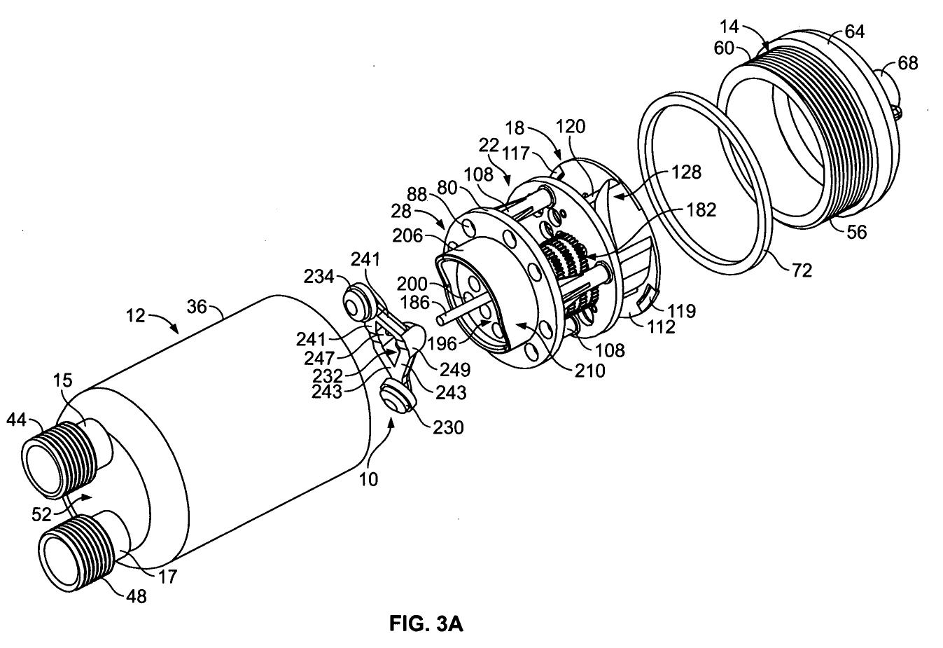

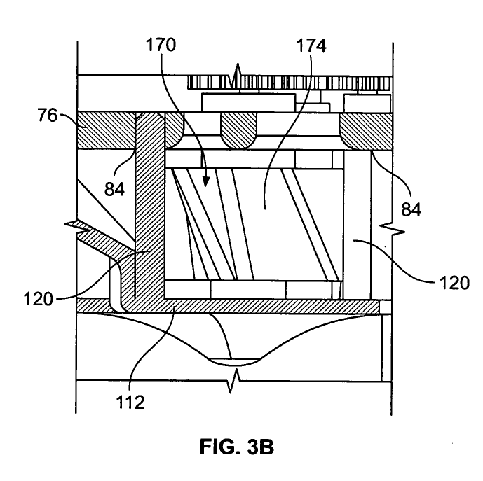

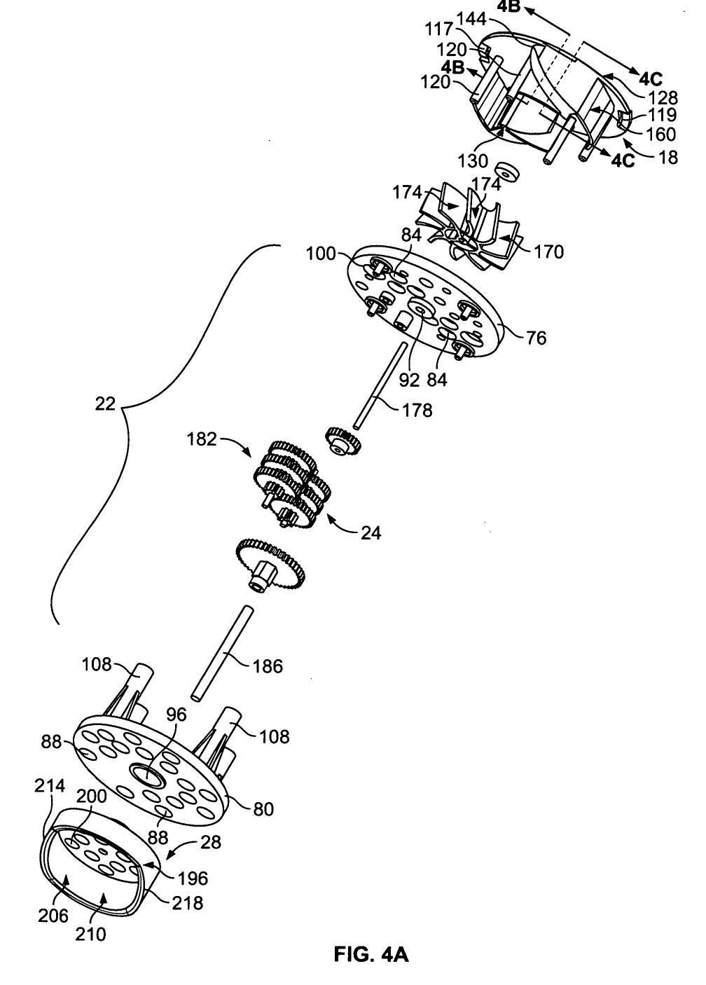

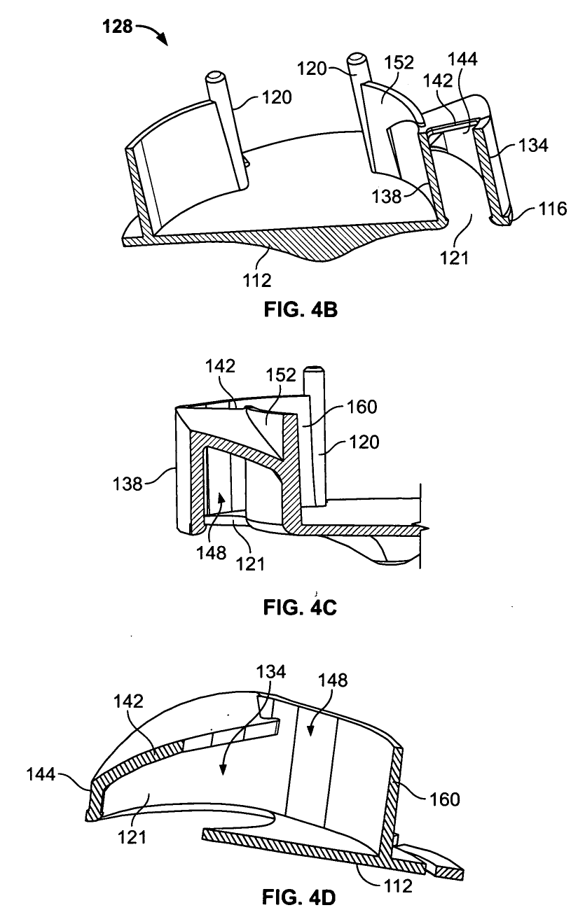

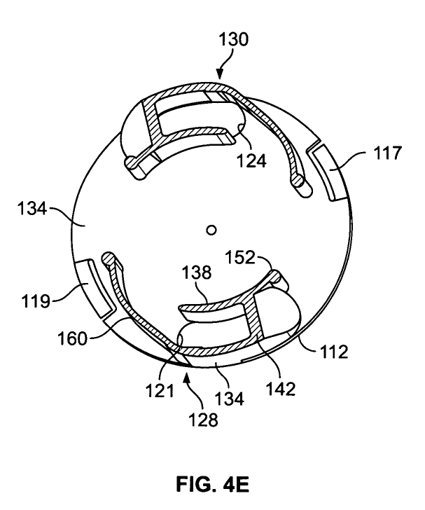

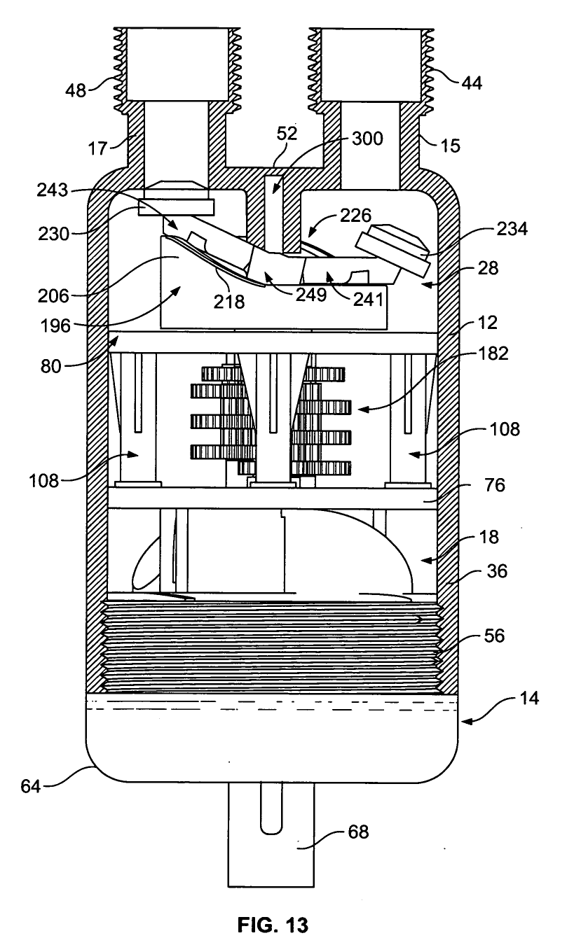

The liquid-passage assembly 22 comprises a perforated member 76 coupled to perforated member 80. Perforated members 76 and 80 respectively include a plurality of openings 84 and 88. Perforated members 76 and 80 respectively also include hubs 92 and 96 for rotatably supporting the drive assembly 24. Perforated member 76 is formed with four (4) protruding pins 100 which engage bores 104 of shaft members 108 which are bound to perforated member 80, as best shown in FIGS. 3A and 4. As illustrated in FIG. 15, liquid passes from the diverter assembly 18 respectively through openings 84 and 88 of the coupled perforated members 76 and 80.

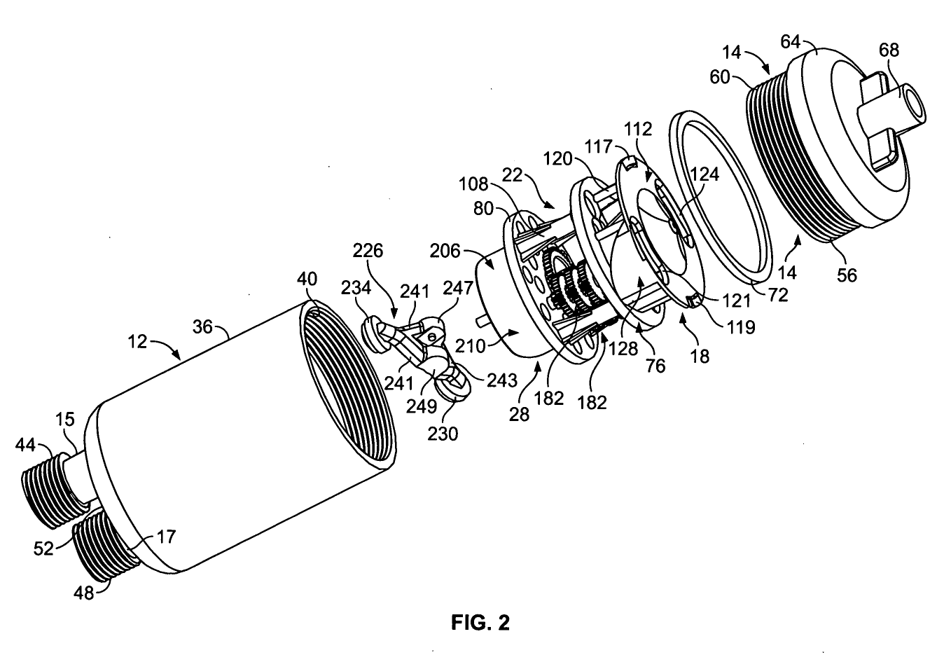

The diverter assembly 18 has a support member 112 including a circumferential edge 116, which has a pair of flexible drag fingers 117 and 119 that are capable flexing toward a concentric axis. Drag fingers 117 and 119 flex upon coming in contact with flowing, pressurized fluid. The support member 112 has a pair of openings 121 and 124 through which liquid passes for introduction into liquid-diverter chamber assemblies 128 and 130. Stanchions 120 are connected to the support member 112 and slide, as best shown in FIG. 3B, into openings 84 in the perforated member 76 for coupling the diverter assembly 18 to the perforated member 76, as illustrated in FIG. 2. As indicated, openings 84 which do not engage stanchions 120 for coupling the diverter assembly 18 to the perforated member 76, are available for passing and/or transmitting liquid through the perforated member 76. As previously mentioned, after liquid passes through openings 84 in the perforated member 76, the liquid subsequently passes through openings 88 of the perforated member 80. Perforated member 76, perforated member 80, and support member 112 of the diverter assembly 18 are coupled together and do not rotate or otherwise move, but remain in a fixed relationship with respect to each other.

Liquid-diverter chamber assemblies 128 and 130 respectively receive and divert the flow of liquid after passing through openings 120 and 124. Liquid-diverter chamber assembly 128 comprises a pair of sloping walls 134 and 138 connected to a sloping top 142, all terminating at point 144 on the support member 112 (see FIG. 4B). A chamber opening 148 is formed by ends of the sloping walls 134 and 138 and the top 142 for providing a liquid-discharge exit for fluid from the liquid-diverter chamber assembly 128. After liquid passes through opening 148, it engages a chamber ramp member 160 for changing and directing the flow of liquid towards the impeller 170. A chamber support member 152 merges with and interconnects the sloping wall 138 with one of the stanchions 120. The chamber ramp member 160 interconnects the end of the sloping wall 134 with another of the stanchions 120. The ramp member 160 functions for directing liquid into, and against the blades (identified as “174” below) of an impeller (identified as “170” below) for driving and rotating the drive assembly 24 for operating and causing the cam assembly 28 to alternately open and close the exit conduits 15 and 17 to cause a liquid to alternately and/or intermittently flow through the exit conduits 15 and 17 of the housing 12. After a pressurized liquid passes through opening 121, it enters the liquid-diverter assembly 128 where its only available exit is through chamber opening 148. After passing through opening 148, it contacts the chamber ramp member 160 for being directed against the blades of the impeller to rotate the same.

Liquid-diverter chamber assembly 128 and liquid-diverter chamber assembly 130 are essentially the same in configuration. Chamber assembly 130 includes the same elements having the same function as the elements of the liquid-diverter chamber assembly 128. More particularly, chamber assembly 130 has a pair of sloping walls, a sloping top, a chamber support member and a chamber ramp member. After a pressurized liquid passes through opening 124, it enters the liquid-diverter assembly 130 where its only available exit is through the associated chamber opening. After passing through the chamber opening of the chamber assembly 130, it contacts the chamber ramp member of the chamber assembly 130 for being directed against the blades of the impeller to rotate the same. Thus, the elements and their associated function for liquid-diverter chamber assembly 130 are essentially the same as the elements and their associated function previously identified and described above for liquid-diverter chamber assembly 128.

The drive assembly 24 operates and/or rotates the cam assembly 28 to cause liquid to flow alternately and/or intermittently through the exit conduits 15 and 17 of the housing 12. The drive assembly 24 comprises an impeller 170 connected or keyed to a shaft 178 which passes through hub 92 of the perforated member 76. The impeller 170 has a plurality of blades 174 which receive pressurized liquid after it is diverted by the diverter assembly 18. The shaft 178 is coupled to a gear assembly 182 which, in turn, is coupled or connected to a shaft 182. It is to be understood that shafts 178 and 182 may be one, integral shaft to which the gear assembly 182 is keyed and which rotates as the diverted liquid from the diverter assembly 18 contacts the blades 174 of the impeller 170 to cause the latter to rotate and, in turn, rotate the one, integral shaft. Shaft 186 rotatably passes through hub 96 of the perforated member 80 to couple to and/or with the cam assembly 28, more specifically to and/or with the cam support member identified as “190” which rotates when shaft 186 rotates to for operating and/or rotating the cam assembly 28.

The number of gears in the gear assembly 182 dictates the amount of gear reduction desired in order to control the rate in which the drive assembly 24 operates and/or rotates the cam assembly 28. The rate at which the cam support member 196 turns controls the rate at which the rocker assembly 226 moves back and forth, which ultimately controls the rate in which liquid alternately and/or intermittently flows through the exit conduits 15 and 17 of the housing 12. Broadly, by adding or subtracting/removing gears from the gear assembly 182 determines the rate of rotation of the shaft 186, which in turn determines the rate that the cam assembly 28 operates and/or rotates, and ultimately the rate at which the rocker assembly 226 moves back and forth, which ultimately controls the rate in which liquid alternately and/or intermittently flows through the exit conduits 15 and 17 of the housing 12. The more gears added to the gear assembly 182, the slower the rate of rotation of the shaft 186. The more gears removed from the gear assembly 182, the faster the shaft 186 rotates.

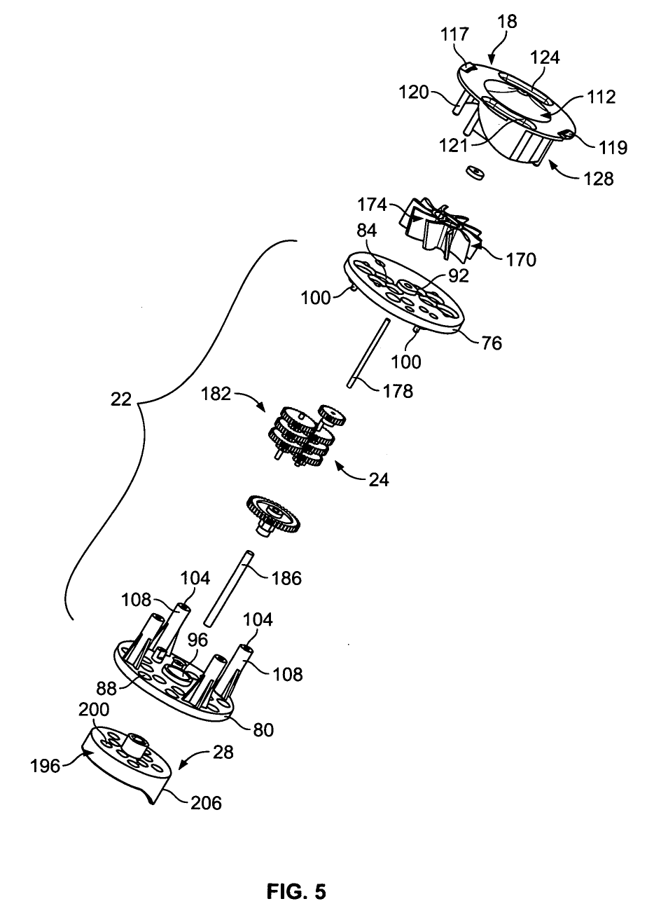

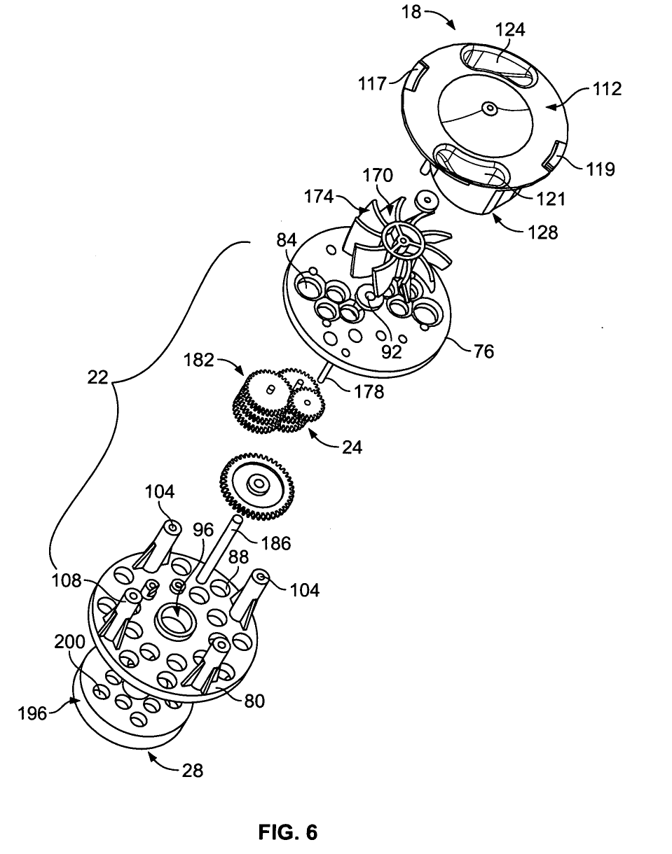

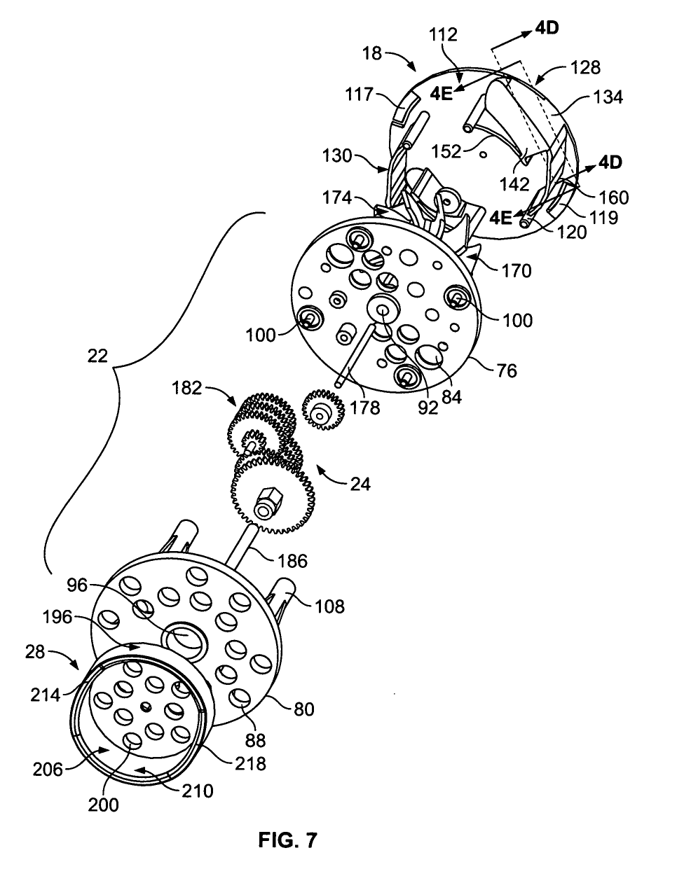

In a preferred embodiment of the invention, as best illustrated in FIGS. 8-10, the gear assembly 182 includes gear 182a coupled to shaft 178 to rotate therewith. Gear 182a meshes with gear 182b to rotate the latter. As gear 182b rotates, shaft 183 rotates which causes gears drive gears 182c and drive gears 182d to rotate. Drive gears 182c translate rotation to gears 182e, gear 182g, and gears 182f, all supported rotationally by shaft 184 to rotate therewith. Gear 182g translates rotation to gear 182h which causes the shaft 186 to rotate since shaft 186 rotationally supports gear 182h.

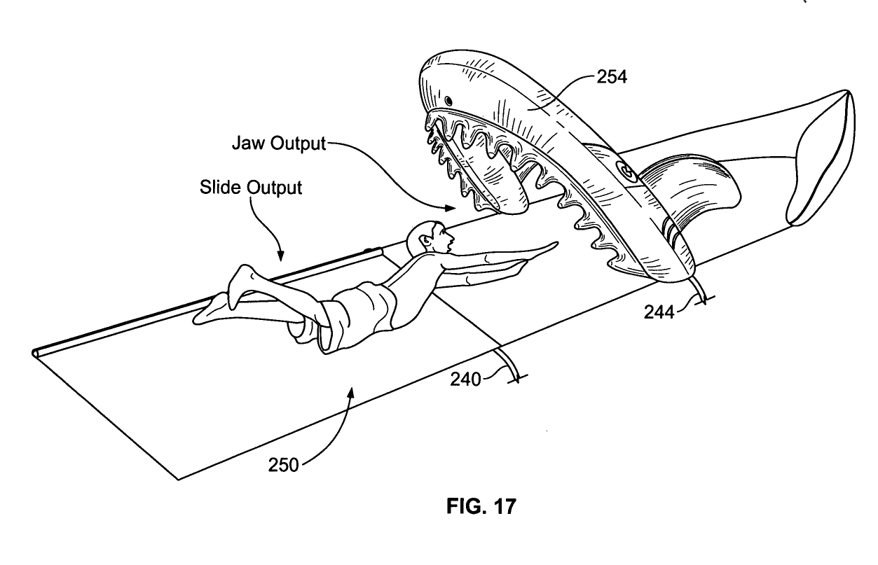

The cam assembly 28 is operated by the drive assembly 24. The cam assembly 28 comprises a perforated cam support 196 having apertures 200 through which liquid passes after passing through openings 88 in the perforated member 80. The shaft 186 passes through the hub 96 and is coupled to the perforated member 80 so that when shaft 186 rotates, the perforated member 80 rotates. Integrally connected or coupled to the perforated cam support 196 is a sloping wall 210 having ends 214 and 218 that gradually slope upwardly from the cam support member 196. A shaft 300 is coupled to or bound to the inside surface of end 52 of the housing 12. The shaft 300 has a bore 235 passing through it (see FIG. 19) and is general co-axial and concentric with the cam support 196 while not rotating with the same.

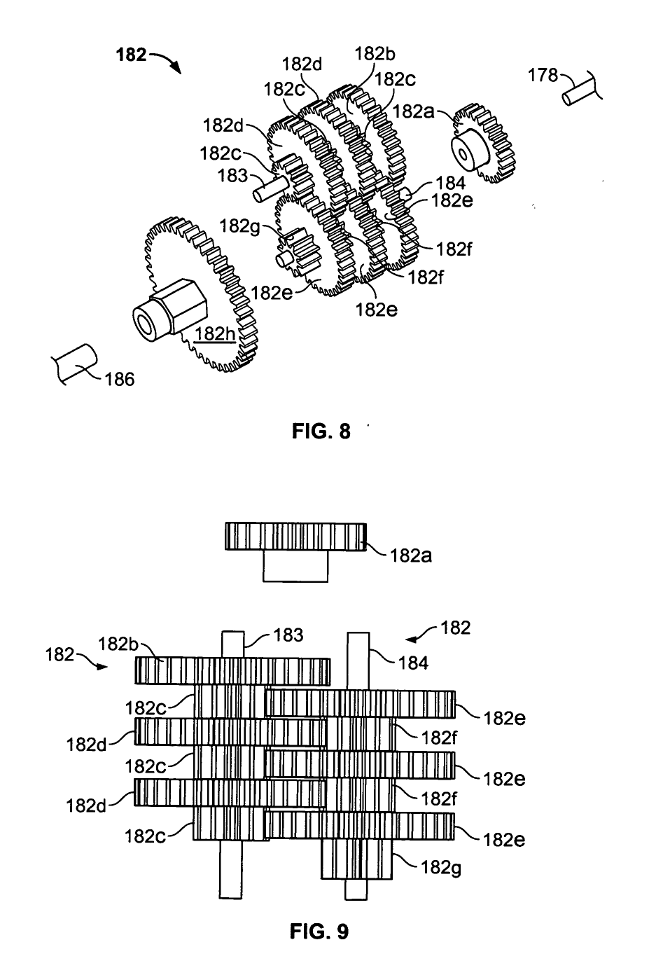

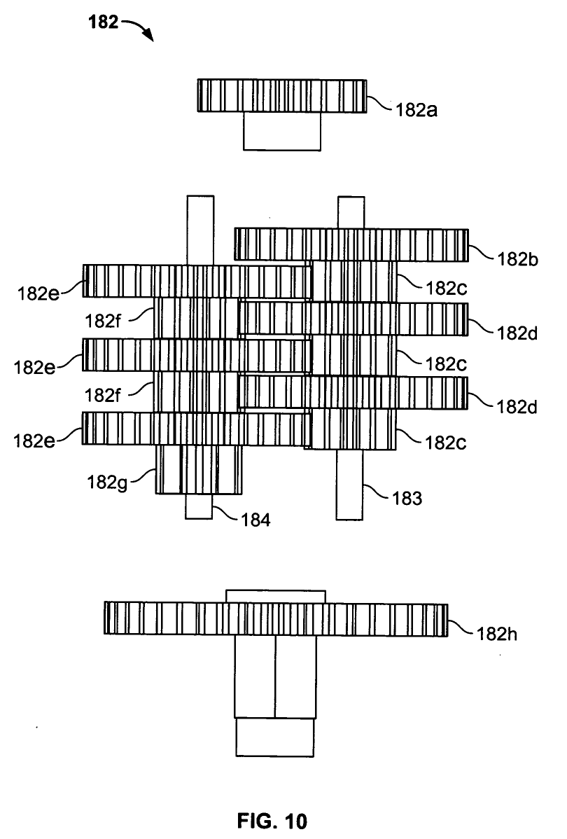

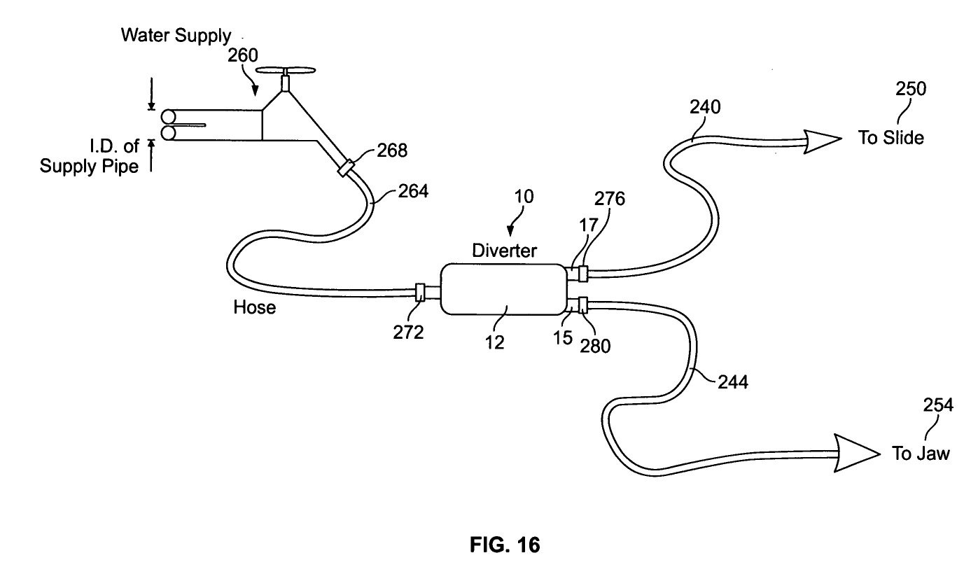

The cam assembly 28 also includes a rocker member 226 having a pair of bifurcated rocker arms 241 and 243 bonding together to form a rocker opening 232. The rocker arms 241 and 243 respectively support a pair of opposed fluid-flow stoppers 234 and 230 for intermittently engaging and covering fluid-introduction openings on the fluid-intake ends of the exit conduits 17 and 15, respectively. The shaft 300 passes through the opening 232 (see FIG. 11) formed by the bifurcated rocker arms 241 and 243. A pair of depending skirts 249 and 247 extends downwardly from the binding points of the bifurcated rocker arms 241 and 243. A pin member 233 extends from depending skirt 249 to depending skirt 247 and is bound and/or affixed to both skirts. The pin member 233 passes through the bore 235 (see FIGS. 18 and 19) of the shaft 300 such as to be capable of at least partially rotating within the bore 235 to enable the rocker member 226 to rock back and forth (see arrows in FIGS. 18 and 19).

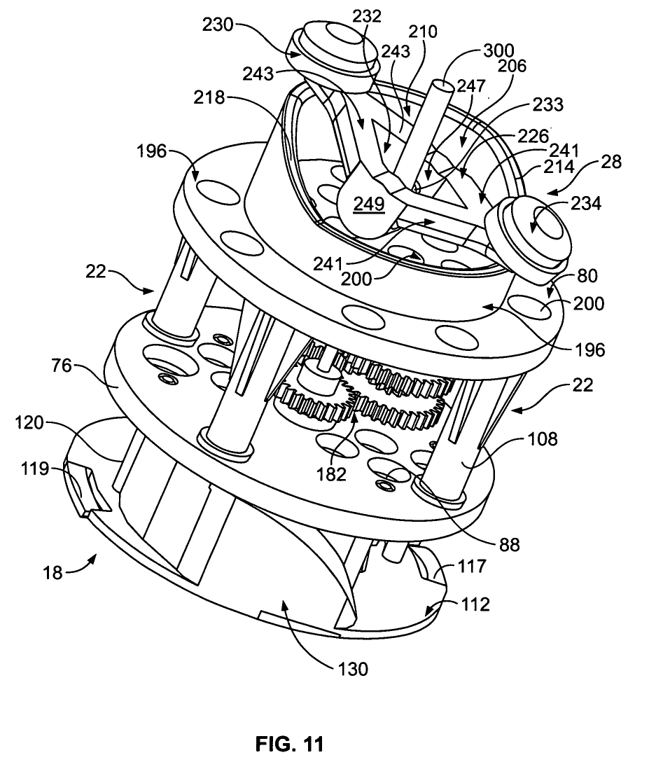

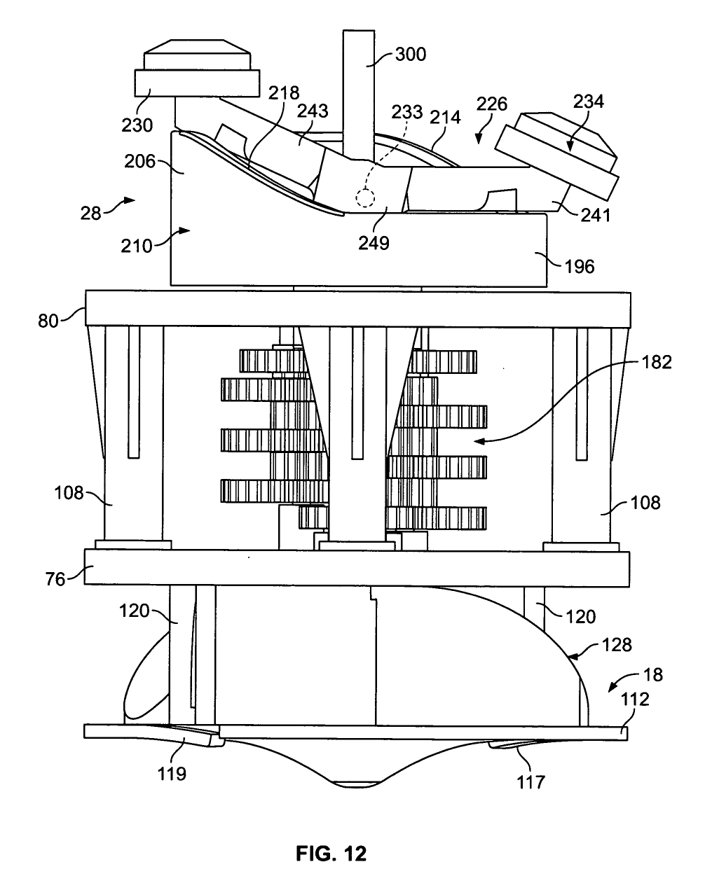

The rocking movement (like a teeter totter) of the rocker member 226 from pin member 233 rotating back and forth within bore 233 of the shaft 300 enables the fluid-flow stoppers 230 and 234 to intermittently engage and cover the fluid-introduction openings on the fluid-intake ends of the exit conduits 217 and 215, respectively. The rocking movement of the rocker member 226 occurs when the rocker arm 243 supporting fluid-flow stopper 230 is traveling up the end 218 of the sloping wall 210 while the rocker arm 241 supporting fluid-flow stopper 234 is traveling down the end 214 of the sloping wall 210. As this occurs fluid-flow stopper 230 comes in contact the fluid-intake end of the exit conduit 17 (see FIG. 13) while the fluid-flow stopper 234 leaves the fluid-intake end of the exit conduit 15 which allows liquid to pass through exit conduit 15.

The rocking movement of the rocker member 226 continues to occur when the rocker arm 241 supporting fluid-flow stopper 234 is traveling up the end 218 of the sloping wall 210 while the rocker arm 243 supporting fluid-flow stopper 230 is traveling down the end 214 of the sloping wall 210. As this occurs fluid-flow stopper 230 comes in contact with the fluid-intake end of the exit conduit 15 (see FIG. 13) while the fluid-flow stopper 230 leaves the fluid-intake end of the exit conduit 17 which allows liquid to pass through exit conduit 17.

Referring now to FIG. 15, there are seen arrows which represent the flow of a liquid. When a liquid leaves the inlet assembly 14, it passes through openings 121 and 124 of the support member 112 and respectively enters liquid-diverter assemblies 128 and 130. In each of the diverter assemblies, the direction of flow of the liquid is altered such as to impact the blades 174 of the impeller 170 to cause the impeller 170 to rotate the shaft 176. The rotational movement of the shaft 176 is translated through the gear assembly 182 to turn the cam assembly 28 (e.g., the perforated cam support member 196) for moving the rocker member 226 back and forth to alternately open and close the exit conduits 15 and 17.

Each of the diverter assemblies 128 and 130 has a ramp for directing the flow of liquid against the blades 174 of the impeller 170. After the liquid leaves the blades 174 of the impeller 170, the liquid flows through openings 84 of the perforated member 76. After the liquid passes through openings 84 of the perforated member 76, it passes by the gear assembly 182 and subsequently through openings 88 of the perforated member 88, and then through apertures 200 of the rotating perforated cam support member 196. As previously indicated, as the cam assembly 28 moves the rocker member 226 back and forth, the exit conduits 15 and 17 are alternately opened and closed. When one exit conduit is opened, the liquid flows through the opened exit conduit. As the rocker member 226 begins to close one exit conduit and open the other exit conduit, both exit conduits (i.e., exit conduits 15 and 17) are temporarily opened to enable the liquid to flow through both exit conduits. After the rocker member 226 subsequently finishes closing the exit conduit that was initially opened and distributing liquid, the rocker member 226 maintains the exit conduit that was initially closed off in an opened posture so that fluid may flow and be distributed through this conduit. The procedure is continually repeated as the rocker member 226 rocks back and forth.

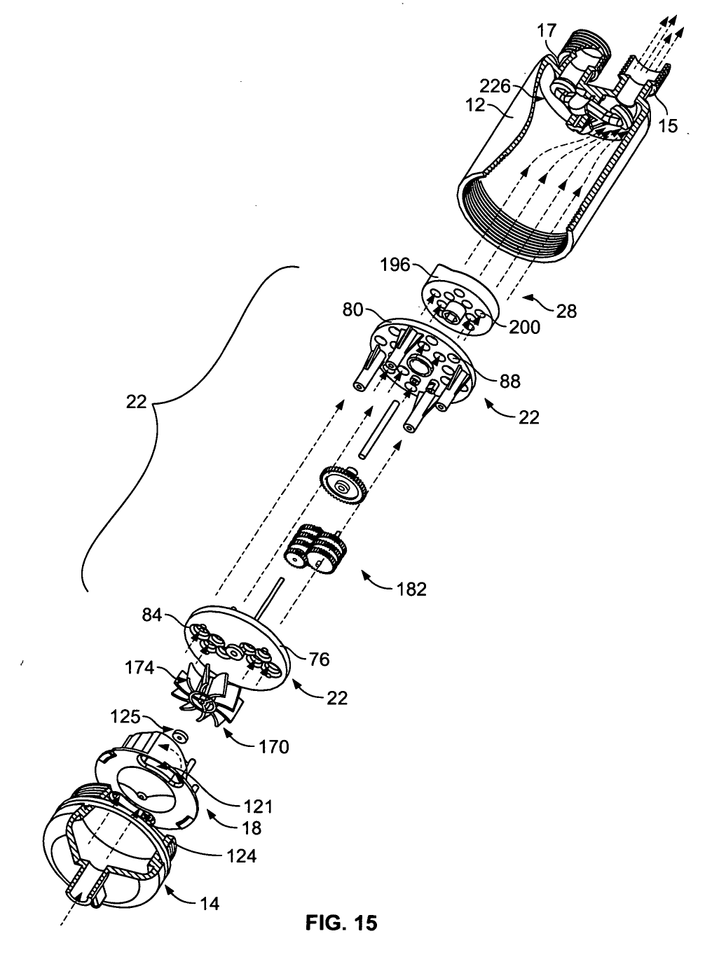

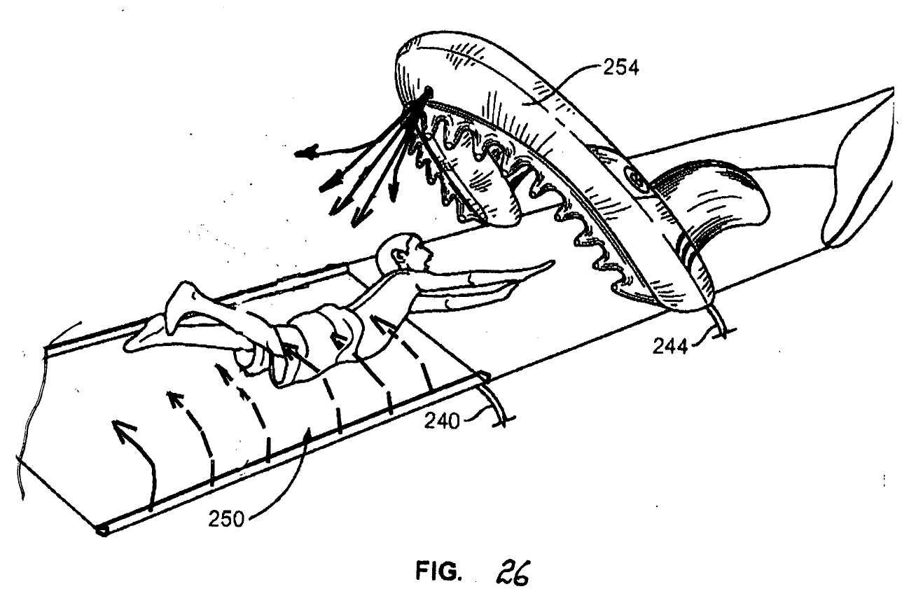

As a liquid alternately and/or intermittently flows (or be distributed) through the exit conduits 15 and 17 of the housing 12, the liquid alternately and/or intermittently flows through conduits 240 and 244 to devices that emit or discharge the liquid. Preferably, the devices that emit liquid disperse or spray, or other wise distribute, the liquid (e.g., water or any other aqueous base liquid). More preferably, the devices alternately and/or intermittently distribute or spray or disperse the liquid. In a preferred embodiment of the invention, as best illustrated in FIG. 17, the devices include a slide member 250 and a movable member (e.g., the jaw shaped member) 254 that respectively receive the liquid from conduits 240 and 244. In a further embodiment of the invention, liquid is dispersed from the devices (e.g., the slide member 250 and the jaw shaped member 254) in accordance with the direction of the arrows illustrated in FIG. 26.

When liquid enters movable member 254, the liquid is discharged under pressure outwardly to cause the movable member 254 to move and/or pivot upwardly and away from the slide member 250. When liquid is not entering the movable member 254, the movable member 254 (because of its weight) moves or pivots downwardly towards the slide member 250. When the liquid is dispersed or sprayed onto the slide member 250, it becomes lubricated to the extent that a person may easily slide longitudinally along the slide member 250, especially when the movable member 254 is an open position which allows the person to slide through an opening between the slide member 250 and the movable member 254 after the latter has been pivoted away from the slide member 250.

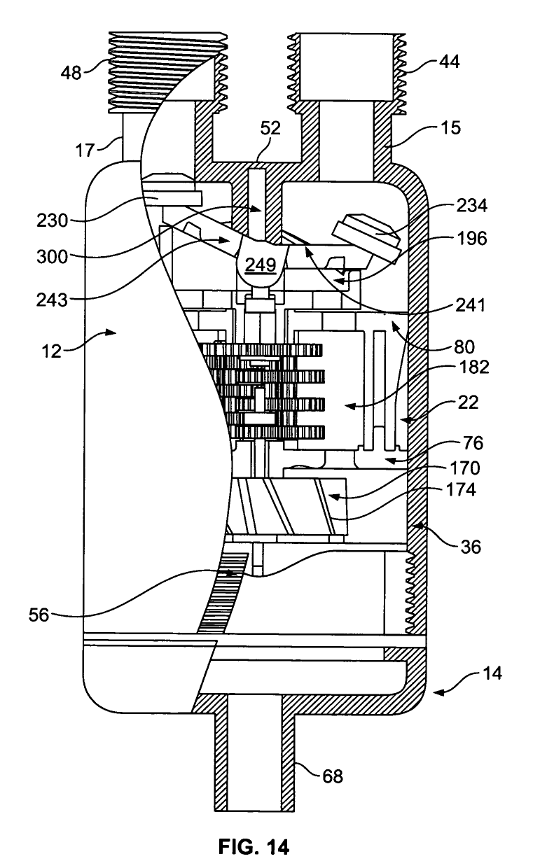

In the schematic diagram illustrated in FIG. 16, there is seen a water source 260 (a facet), a conduit 264 extending from the water source 260 to the diverter assembly 10. Pressure reading locations 268, 272, 276, and 280 may be conveniently placed in desired locations in the system illustrated in FIG. 16.

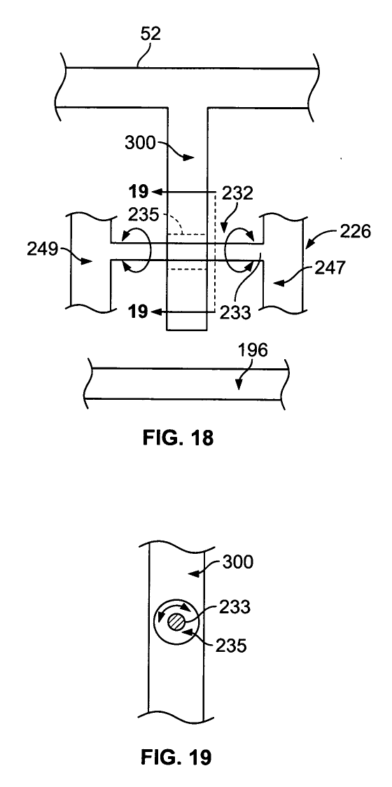

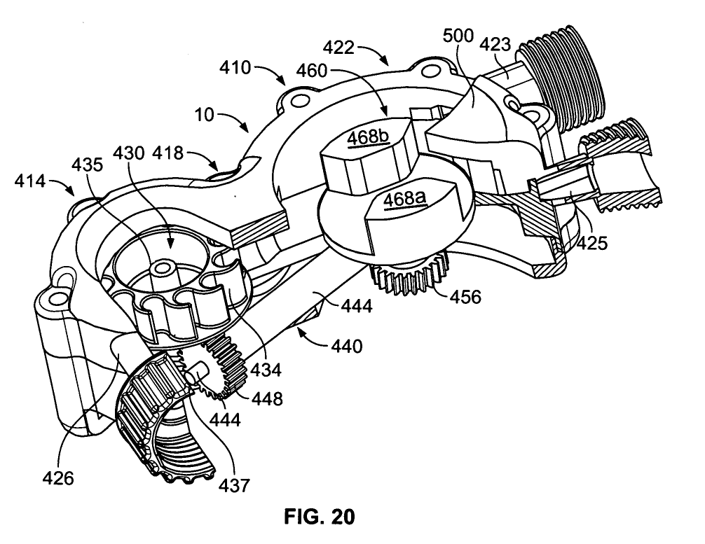

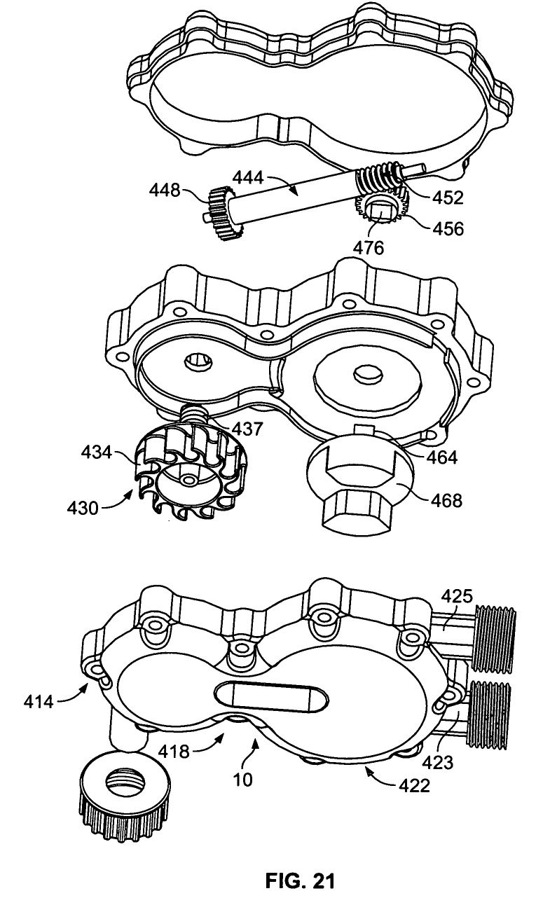

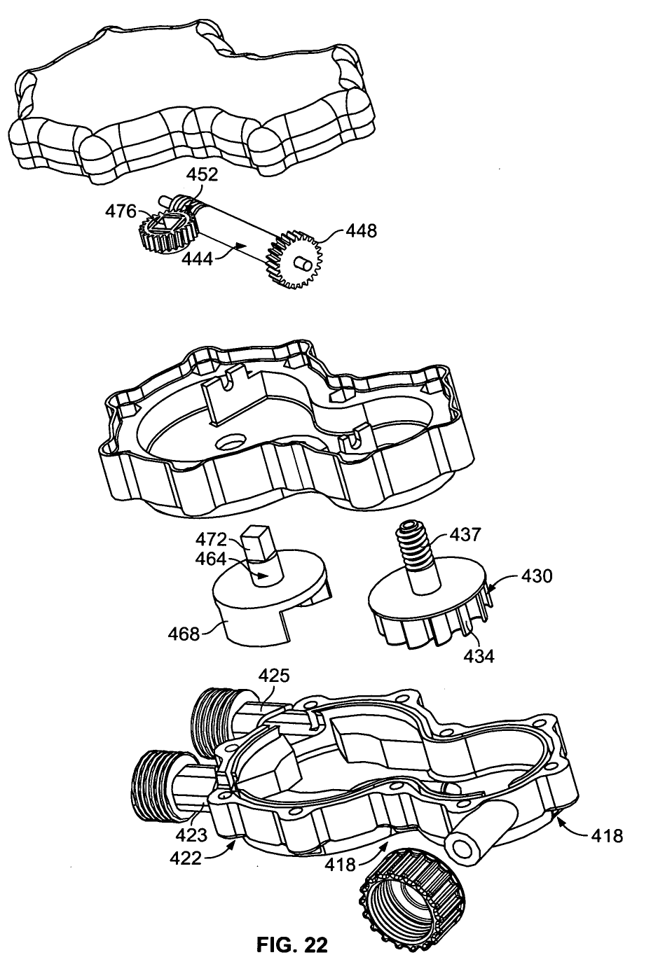

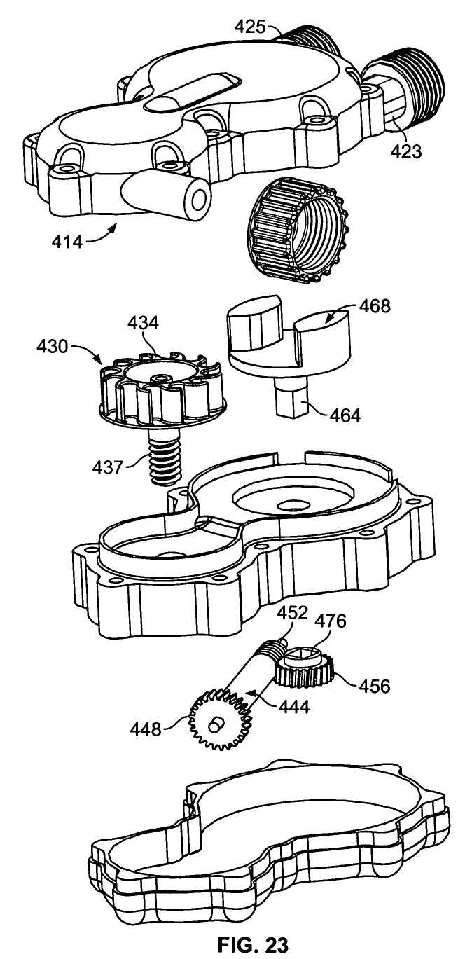

Referring now to FIGS. 20-25 there is seen another embodiment of the diverter assembly 10. In FIG. 20 there is seen a housing, generally illustrated as 410. Housing 410 includes inlet housing 414, middle housing 418, and outlet housing 422. The outlet housing 422 integrally includes a generally equilateral triangularly-shaped tongue section 500 as best shown in FIGS. 20 and 24. The tongue section 500 is integral with the top of the outlet housing 422, but has been segmented from the top of the outlet housing 422 strictly and entirely for purpose of explaining operation and movement of the diverter cam member 468 relative to the part of the outlet housing 422 represented by the generally equilateral triangularly-shaped tongue section 500. Thus, tongue section 500 is not a separate element or structure standing entirely alone, but is a structure that forms part of the structure (i.e., the top structure) of the outlet housing 422.

An inlet conduit 426 connects to the inlet housing 414 for introducing a liquid to contact an impeller 430 which is rotatably disposed in the inlet housing 414. Outlet conduits 423 and 425 connect to the outlet housing 422 for alternate and/or intermittently discharging liquid. The impeller 430 is mounted on a shaft 435 which turns with the impeller 430. The shaft 435 has a depending gear-shaped surface 437 to define a shaft gear. The impeller 430 has blades 434 which may be slanted to assist in receiving and discharging a liquid after contacting the blades 434.

As the impeller 430 turns from pressurized liquid being introduced into the inlet housing 414, the rotary motion of the impeller 430 is translated through the gear-shaped surface 437 of the shaft 435 to a gear assembly, general illustrated as 440. The gear assembly 440 is preferably a worm gear assembly having a gear shaft 444 supporting gear 448 which meshes with the gear-shaped surface 437 of the shaft 435 such that as shaft 435 turns from pressurized liquid contacting the blades 434 of the impeller 430, the gear-shaped surface 437 of the shaft 435 turns gear 448 that is meshed with the gear-shaped surface 437. The gear assembly 440 also includes an output gear 452 mounted to an end of the gear shaft 444 to rotate with the gear shaft 444. As the gear-shaped surface 437 of shaft 435 rotates, supporting gear 448 rotates. As supporting gear 448 rotates, gear shaft 444 rotates, causing gear-shaped surface 452 to rotate. When the gear shaped surface 452 rotates, the output gear 456 rotates.

The gear assembly 440 is coupled to a cam assembly, generally illustrated as 460 in FIG. 20. More specifically, the cam assembly 460 includes a cam shaft 464 bound to a diverter cam member 468. The diverter cam member 468 includes a pair of opposed geometric shaped members 468a and 468b. The cam shaft 464 is keyed to the output gear 456 of the gear assembly 440. The cam shaft 464 has the square/rectangular shaped end 472 that mates with a square/rectangular shaped opening 476 in the output gear 476 such that when output gear 456 rotates, cam shaft 464 rotates and causes the cam member 468 to also rotate. The diverter cam member 468 is geometrically shaped to enable fluid to be alternately and/or intermittently discharge through outlet conduits 423 and 425.

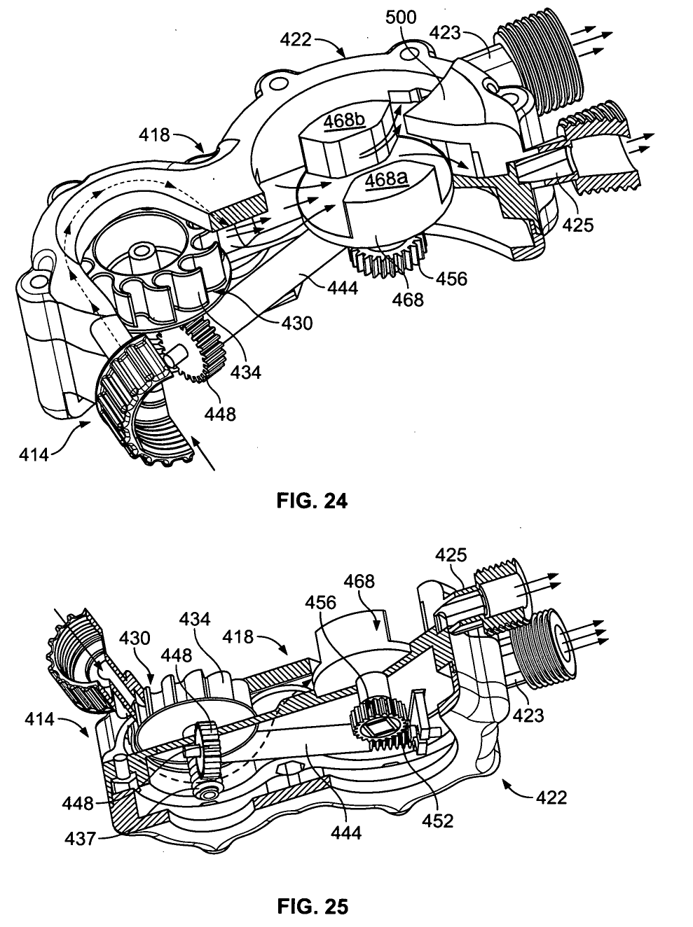

Referring now to FIGS. 24 and 25 there are seen arrows representing the flow of a liquid through the diverter assembly 10 of FIGS. 20-23. A liquid flows into the inlet housing 414 to contact the blades 434 of the impeller 430 and cause the latter to rotate. As impeller 430 rotates, the gear assembly 440 is being driven. After the liquid exits the impeller 430, it flows through the middle housing 418 and into the outlet housing 422 where the liquid comes in contact with the diverter cam member 468 which alternately and/or intermittently discharges the liquid through the outlet conduits 423 and 425. Flow from the diverter cam member 468 generally alternates back and forth between outlet conduit 423 and outlet conduit 425.

In an embodiment of the invention, the diverter cam member 468 continually rotates in either direction; i.e. clockwise or counter-clockwise. The direction of rotation of the cam member 468 depends on the direction of rotation of the impeller and gears. As the diverter cam member 468 rotates, the pair of opposed geometric shaped members 468a and 468b respectively, alternately passes at least partly under, and/or passing contactly against, or in close proximity to, the generally equilateral triangularly-shaped tongue section 500 which preferably integrally forms part of the top of the outlet housing 422. When at least part of one of the geometric shaped member (i.e., 468a or 468b) is in passing contact under, or in close proximity to being under, the structural section of the outlet housing 422 represented by the generally equilateral triangularly-shaped tongue section 500, a contiguous outlet conduit (i.e., 423 or 425) is closed while the other outlet conduit is opened. When none of the opposed geometric shaped members 468a and 468b are in passing contact under, or in proximity to being under, at least part of the structural section of the outlet housing 422 represented by the generally equilateral triangularly-shaped tongue section 500, both outlet conduits 423 and 425 are opened.

Stated alternatively, when one outlet conduit is opened, the liquid flows through the opened exit conduit. As the diverter cam member 468 (e.g., geometric shaped member 468a or 468b) begins to close one outlet conduit and open the other outlet conduit, both outlet conduits (i.e., outlet conduits 423 and 425) are temporarily opened to enable the liquid to flow through both outlet conduits. After the diverter cam member 468 subsequently finishes closing the outlet conduit that was initially opened and distributing liquid, the diverter cam member 468 maintains the outlet conduit that was initially closed off in an opened posture so that fluid may flow and be distributed through this conduit. The procedure is continually repeated as the diverter cam member 468 rotates within outlet housing 422.

In a preferred embodiment of the invention and assuming that the diverter cam member 468 rotates clockwise, when geometric shaped member 468a closes outlet conduit 423, outlet conduit 425 is open. As the diverter cam member 468 continually rotates, geometric shaped member 468a releases from closing outlet conduit 423, and subsequently closes the outlet conduit 425 while releasing the outlet conduit 423 from closure. With further continual rotation of the diverter cam member 468, geometric shaped member 468a releases its closure of outlet conduit 425. At this point in operation of the diverter cam member 468, both outlet conduits 423 and 425 are temporarily opened to enable the liquid to flow through both outlet conduits. Both outlet conduits 423 and 425 remain open until geometric shaped member 468b has rotated around until it closes outlet conduit 425. With yet further continual rotation of the diverter cam member 468, geometric shaped member 468b releases from closing outlet conduit 423, and subsequently closes the outlet conduit 425 while releasing the outlet conduit 423 from closure. As the diverter cam member 468 further continually rotates, geometric shaped member 468b releases its closure of outlet conduit 425, resulting again in both outlet conduits 423 and 425 being temporarily opened to enable the liquid to flow through both outlet conduits. The procedure is continually repeated as the diverter cam member 468 including it associated geometric shaped members 468a and 468b rotate within outlet housing 422.

The water-distributing assemblies or devices for embodiments of the present invention may be any suitable devices that distribute liquid (water). In the spirit and scope of the present invention, the movable device or movable water-distributing device is not limited to the jaw shaped member 254 (i.e., shark-appearing device that is illustrated in FIG. 16). In the spirit and scope of the present invention, and as previously indicated, the movable liquid (water) distributing device is not limited to a device which merely disperses or distributes water intermittently. Nor is the movable liquid (water) distributing device limited to a device that moves, pivots or creates motion.

Thus, practice of various embodiments of the present invention employs no electronics, but only water pressure and/or the flow of water to drive a diverter assembly 10 that alternately diverts the flow of water from exit conduit 15 to exit conduit 17 and from exit conduit 17 to exit conduit 15. The diverter assembly 10 is also capable of simultaneously passing water through both exit conduits 15 and 17. An advantage to practicing various embodiments of the present invention over watering systems that employ electromechanical devices is the elimination of using electronics near water, which could cause electrical shock to the user, or corrosion to the device. Additionally, practice of various embodiments of the present invention functionally requires the user to merely attach a diverter assembly 10 to a garden hose and open the water valve to commence the flow of water. No electronic switches, or batteries, or programming are required. Furthermore, the cost of the components of the diverter assembly 10 for various embodiments of the present invention is lower than the cost of components of conventional diverter devices. Many conventional water-dispersing devices require a minimum amount of water pressure and flow to operate. However, the diverter assembly 10 for embodiments of the present invention does not require a minimum amount of water pressure and/or water flow rate to operate efficiently. Thus, the user may couple two or more diverter assemblies 10 to a common water source (e.g., a single water hose) without any disruption, non-effectiveness or inefficiency of intended function for each diverter assembly 10.

It is to be understood that any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. An assembly for intermittently dispersing a liquid, comprising:
a non-electrical diverter assembly for receiving and alternately distributing a liquid;
a first dispersing assembly communicating with the non-electrical diverter assembly for intermittently dispersing the liquid received from the non-electrical diverter assembly; and
a second dispersing assembly communicating with the diverter assembly for intermittently dispersing the liquid received from the non-electrical diverter assembly.

2. The assembly of claim 1 wherein said non-electrical diverter assembly comprises a support member having at least one opening; and at least one diverter assembly supported by said support member and communicating with said opening for receiving and diverting the liquid passing through the opening.

3. The assembly of claim 2 wherein said non-electrical diverter assembly additionally comprises a first perforated member coupled to said support member.

4. The assembly of claim 3 wherein said non-electrical diverter assembly additionally comprises an impeller member disposed between said support member and said first perforated member.

5. The assembly of claim 4 wherein said non-electrical diverter assembly additionally comprises a second perforated member coupled to said first perforated member.

6. The assembly of claim 5 wherein said non-electrical diverter assembly additionally comprises a gear assembly disposed between said first perforated member and said second perforated member and coupled to said impeller member.

7. The assembly of claim 6 wherein said non-electrical diverter assembly additionally comprises a cam assembly coupled to said gear assembly.

8. The assembly of claim 7 wherein said cam assembly comprises a perforated cam support member having apertures through which the liquid passes; and a rocker assembly supported by said cam support member.

9. The assembly of claim 8 wherein said perforated cam support member comprises a member for causing the rocker assembly to rock back and forth.

10. The assembly of claim 8 wherein the first dispersing assembly comprises an assembly for receiving flowing liquid from the non-electrical diverter assembly and intermittently dispersing the liquid to the second dispersing assembly.

11. The assembly of claim 10 wherein the second dispersing assembly receives intermittently dispersed liquid from the first dispersing assembly and subsequently intermittently disperses the liquid.

12. The assembly of claim 11 wherein said second dispersing assembly comprises a slide member and a movable member for intermittently moving towards and away from the slide member.

13. A non-electrical diverter assembly for receiving and alternately distributing a liquid comprising: a housing, a diverter device disposed in the housing for altering the direction of flow of a liquid; a fluid transmission assembly disposed in the housing for passing the liquid; a drive assembly disposed in the housing and rotatably supported by the fluid transmission assembly and operating from the flow of liquid diverted by the diverter device; and a cam assembly disposed in the housing and coupled to the drive assembly for alternately distributing the liquid from the housing.

14. The non-electrical diverter assembly of claim 13 wherein said diverter device comprises a support member, and at least one diverter member supported by said support member for diverting the flow of the liquid.

15. The non-electrical diverter assembly of claim 14 wherein said drive assembly comprises an impeller member for receiving diverted liquid produced by the diverter device.

16. The non-electrical diverter assembly of claim 15 wherein said cam assembly comprises a perforated cam support member having apertures through which the liquid passes; and a rocker assembly supported by said cam support member.

17. The non-electrical diverter assembly of claim 16 wherein said perforated cam support member comprises a member for causing the rocker assembly to rock back and forth.

18. The non-electrical diverter assembly of claim 17 wherein said member comprises a wall member secured to said perforated cam support member and generally sloping upwardly from the perforated cam support member.

19. A method for alternately distributing a liquid, comprising:
flowing a liquid into a housing;
diverting the liquid within the housing;
contacting an impeller member with the diverted liquid for operating a cam assembly; and
alternately distributing the liquid from the housing by operation of the cam assembly.

20. The method of claim 19 wherein said diverting the liquid comprises passing the liquid through an opening in a support member into a diverter assembly supported by said support member.
